(19) United States
(12) Patent Application Publication
(10) Pub. No.: US 2004/0083136 A1
(43) Pub. Date: Apr. 29, 2004

(54) User interface, system, and method for providing access to construction services

(76) Inventor: James E. Sasser, Houston, TX (US)

Correspondence Address: Gary R. Maze, Duane Morris LLP, One Greenway Plaza, Suite 500, Houston, TX, 77046, US

(21) Appl. No.: 10/281,005

(22) Filed: Oct. 25, 2002

(51) Int. Cl. G06F 17/60

(52) U.S. Cl. 705/26

(57) ABSTRACT

A user interface, system, and method for providing access to construction services are disclosed. In the user interface, a plurality of regions comprise user interface elements useful for setting a construction service context and for providing additional information in the construction service context. Using the user interface, a user can create a plan for construction services and access a construction context sensitive directory of construction services providers where the directory may further comprise a rating for a predetermined set of the providers and an access function to access the provider. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### FIELD OF INVENTION

The present invention relates to providing access to construction services and materials, and more particularly to a user interface, system, and method useful in providing access to construction services and materials.

### BACKGROUND OF THE INVENTION

Potential consumers of construction services and materials often need to gather information regarding numerous facets of a construction project into one final plan. If the information is not gathered and organized correctly, construction may be delayed, costs may exceed a budgeted or desired amount, or critical steps or materials may be omitted or have to be completed out of sequence.

Products exist by which a potential consumer of construction services may obtain information about or obtain materials for desired construction services. However, these products do not provide a single tool or user interface by which information relevant to a project in a certain geographic area may be gathered, planned, investigated, or selected, or by which a final construction plan may be implemented.

Further, these products do not provide an interface through which a potential consumer may selectively compare ratings on materials and/or labor and/or service providers and/or solicit and obtain information and bids from desired providers of materials and/or labor and/or service providers.

### BRIEF DESCRIPTION OF THE DRAWINGS

The features, aspects, and advantages of the present invention will become more fully apparent from the following description, appended claims, and accompanying drawings in which:

FIG. 1 is a schematic overview of an exemplary system;

FIG. 2 is a first exemplary display of a user interface;

FIG. 3 is a second exemplary display of a user interface;

FIG. 4 is an exemplary rating display;

FIG. 5 is an exemplary provider questionnaire;

FIG. 6 is an exemplary bid form;

FIG. 7 is an exemplary project plan chart; and

FIG. 8 is a flowchart of an exemplary method.

### DETAILED DESCRIPTION OF THE PREFERRED EMBODIMENT

In general, throughout this description, if an item is described as implemented in software, it can equally well be implemented as hardware.

As used herein, “data” is either singular or plural, as the context requires.

Further, as used herein, a “project plan” may comprise a timeline containing estimated timing, i.e., the time it will take to complete the portion of a construction related project. A project plan may further comprise details such as cost, materials, and labor components. Timelines may further comprise a portion describing one or more “stages” of construction and information relevant to a stage. For example, a stage may include one or more “construction elements,” e.g. a construction step and/or material, which occur before the consumer buys or builds, a construction step and/or material which occurs when construction or foundations are initiated, a construction step and/or material which occurs when structure construction is being accomplished, a construction step and/or material which occurs when an interior construction is being accomplished, a construction step and/or material which occurs when an exterior construction is being accomplished, a construction step and/or material which occurs when construction is in the finishing or completion stage, a construction step and/or material which occurs after construction of the structure is completed, or the like.

Further, as used herein, “construction service context” means a set of functions, activities, resources, and/or materials desired for a construction project or service such as may be related to a new residential construction project, an existing residential construction project, an existing residential maintenance project, a new non-residential construction project, an existing non-residential construction project, an existing non-residential maintenance project, or the like, or a combination thereof. Further, a construction “step” or “construction service context step” may comprise financing, insuring, purchasing real property, surveying, designing, engineering, obtaining information about construction, planning, estimating costs, procuring material, procuring labor, expending labor, or the like, or a combination thereof.

As further used herein, “contractor” comprises contractors, subcontractors, contract laborers, contract professionals, and others involved in residential and non-residential construction.

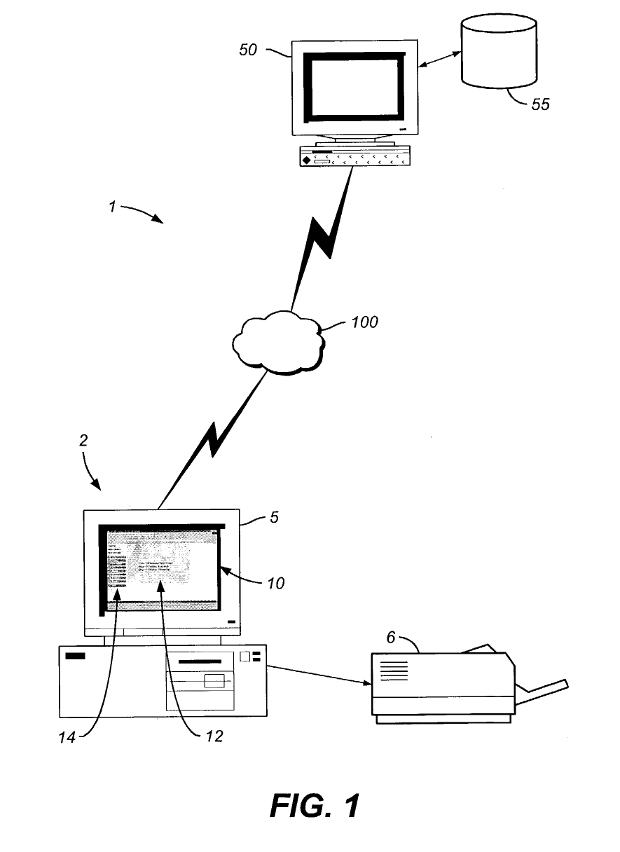

Referring now to FIG. 1, in an exemplary embodiment system I comprises server 50 which may be accessible to another computer such as computer 2 via data network 100. User interface 10 is displayable on display 5 and comprises first region 12 and second region 14. First region 12 and second region 14 may be fixed in location on display 5 or may vary. All or a portion of user interface 10 may be available via one or more display formats available via data network 100 such as a hypertext markup language page available from server 50 over the Internet or further via electronic mail, facsimile, or toll free number, or a combination thereof.

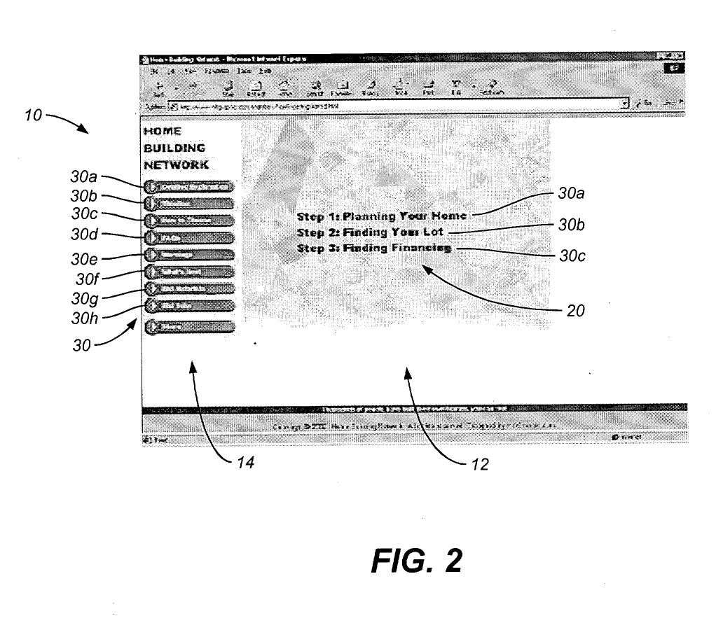

Referring now to FIG. 2, first region 12 further comprises a first user interface element, generally referred to herein using the numeral “20” and more specifically shown in FIG. 2 as first user interface elements 20a, 20b, and 20c. First user interface element 20 is useful for setting a construction service context and may comprise one or more graphical components 24 (not shown in the figures) which may be visually related to the construction service context. As used herein, graphical components 24 may comprise text, photographically derived images such as from video or other photographic images, graphics such as icons or bitmaps, or the like, or a combination thereof. Additionally, graphical components 24 may be presented to a user on user interface 10 in an outline format where at least one first user interface element 20 exists for each of a predetermined set of stages of construction.

Second region 14 further comprises a second user selectable user interface element, generally referred to herein by the numeral “30” and more specifically shown in FIG. 2 as elements 30a through 30h. Second user selectable user interface element 30 is useful for providing additional information related to one or more project steps, e.g. steps to complete a stage in a construction context defined by a selection of user interface element 20 in first region 12 such as by a user. For example, selection of user interface element 20 in first region 12 may set a construction context to be a project for a new residence, and a planning stage for that construction context may include steps comprising choosing a lot, choosing a realtor, choosing a construction lawyer, setting a budget, finding financing, choosing an architect/designer, developing plans, choosing upgrades, choosing a contractor, or asking questions such questions related to that stage, e.g. using user interface 10, electronic mail, facsimile, toll free number, in person or the like, or a combination thereof.

Each second user selectable user interface element 30 may comprise a plurality of user selectable user interface elements, e.g. 30a through 30h, where user selectable user interface elements 30 may comprise detailed information related to a project step. For example, in an exemplary embodiment, user selectable user interface element 30 may comprise a detailed information element 30a; a timeline project scheduling element 30b; a “how to choose” element 30c; an FAQ element 30d; a warnings and checklists element 30e, which may further comprise information regarding conditions or facts about which a user should be aware, e.g. common mistakes or omissions, or a checklist which helps define what constitutes a correctly completed step; a “what's next” element 30f; a bid materials element 30g; and a bid services element 30h. Responses, e.g. to FAQ inquiries, may be available via user interface 10, electronic mail, facsimile, toll free number, in person, or a combination thereof

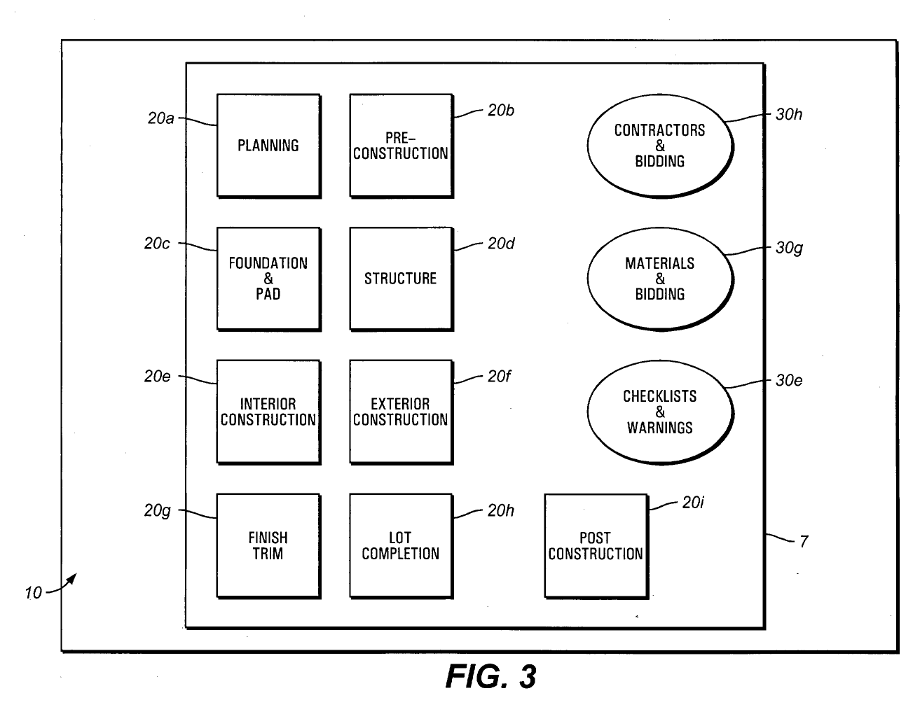

In an exemplary embodiment, a detailed description of a construction stage or step associated with user selectable user interface element 30 may further reflect one or more alternatives, e.g. an analysis of relative cost versus quality or other factors such as durability or longevity of elements present in a construction service context step or stage. For example, referring now to FIG. 3, navigation display 7 may be displayed on display 5 (FIG. 1) to allow a user to choose between one or more stages of construction such as by using-first user interface element 20 and/or second user interface element 30 which represent a predetermined one of the stages of construction. These stages of construction may include a planning stage, a pre-construction stage, a foundation stage, a structure construction stage, an interior construction stage, an exterior construction stage, a finish construction stage, a lot completion stage, a post construction stage or the like, or a combination thereof. Additionally, display 5 may further contain additional user selectable user interface elements such as 30e, 30g, and 30h which may allow access to a geographic contractors and service providers function, a materials providers function, a checklists function, a warnings function, and the like.

In an exemplary embodiment, user selectable user interface elements 20,30 may be useful to provide a predetermined response related to the construction service context upon selection of that user selectable user interface element 20,30. For example, selection of a user selectable user interface element 20,30 for a stage may lead to further information about each step of that stage, e.g. detailed information comprising or related to that stage. Access to the further, construction context sensitive information may be accomplished by user selectable user interface elements 20,30 or all or a portion of such further, construction context sensitive information may be additionally available via electronic mail, facsimile, toll free number, in person, or a combination thereof.

In a preferred embodiment, each user selectable user interface element 20,30 will be associated with one or more functions that provide detailed information about a step associated with the user selectable user interface element 20,30. For example, the detailed information may comprise information as to where the desired construction step falls in a project timeline; a “How to Choose” function related to selection of material and/or contractors for the step; warnings and checklists related to the step; frequently asked questions about the step; a question submission function that allows submission via user interface 10, facsimile, electronic mail, toll free number, in person, or a combination thereof, a directory of contractors from which to solicit bids related to the step; a directory of construction suppliers or materials manufacturers to solicit bids for materials; a discussion of a “What's Next” step in the project timeline; a section where regional experts provide their advice; a discussion of legal issues or documents; and the like. In an exemplary embodiment, responses to inquiries and requests for information and/or advice may be provided via user interface 10, electronic mail, facsimile, toll free number, in person or a combination thereof.

Referring back to FIG. 2, user interface 10 may also be used to display a directory of construction service providers (not shown in the figures), e.g. a directory listing contractors, materials suppliers, materials manufacturers, and the like. Construction service providers may include financial service providers, legal services providers, insurance service providers, construction materials providers, construction labor providers, architectural service or home design service providers, engineering service providers, surveying providers, inspection providers, real estate brokerage providers, interior designers, exterior designers, landscape designers, pool designers, lighting designers or the like. As used herein, an interior designer, an exterior designer, and/or a landscape designer may offer services related to furniture, a home theatre, a pool, fencing, landscaping, flooring, decking, window or wall covering, and the like, or combinations thereof.

By way of additional example, the explanation of a stage involving a foundation such as may be associated with detailed information element 30a may include a discussion of the different types of foundations; how each is constructed; a discussion of the relative costs and benefits of each type of foundation; a recommendation from regional experts on which types are recommended for each region; or a combination thereof.

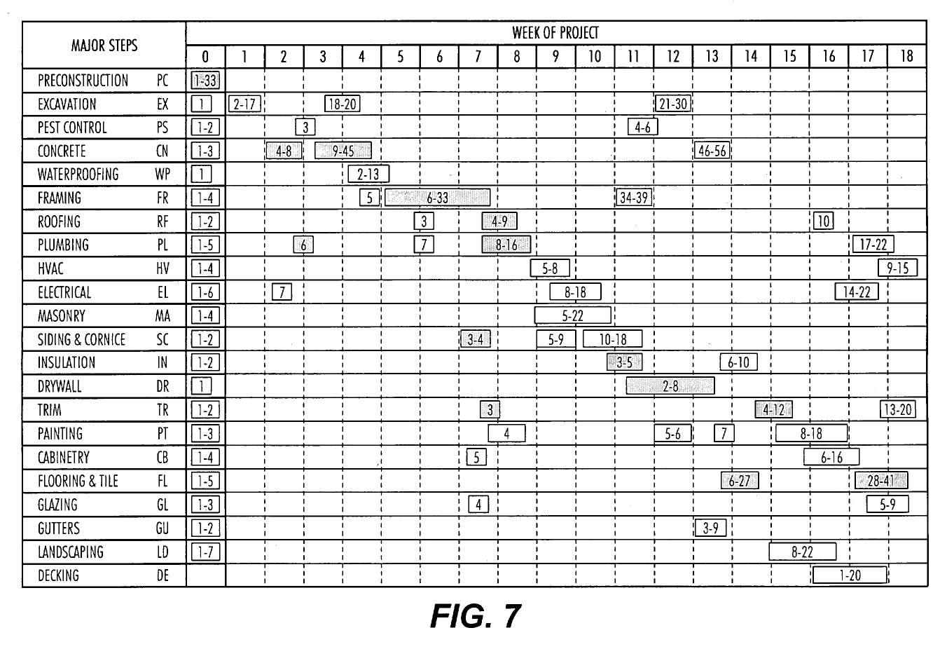

Timeline project scheduling element 30b may comprise detail regarding a project timeline or project plan, e.g. where each step fits into an overall construction timeline; when the step should be scheduled; an estimate of how long each step should take; and a comparison of how much the step costs versus a budget. For example, the foundation work may come after the planning, financing, estimating, land acquisition, and other pre-construction stages. An exemplar of a project plan is illustrated in FIG. 7.

How-to-choose user interface element 30c may be used by a users to access information about specific needs, and may be limited to a specific region, and may include recommendations from regional experts. For example, how-to-choose user interface element 30c may be used to provide information on choosing a contractor for a remodeling project. How to choose user interface element 30c may also be used to provide information on how to choose between materials options and construction alternatives, e.g. by geographic region, as well as the relative cost and quality of a material option and alternative from a regional expert.

FAQ user interface element 30d may be used to provide information in the form of a question and answer format (FAQ) about a predetermined stage. An FAQ may be tutorial in nature, e.g. combine a stylized question and its answer. For example, an FAQ may pose a question on whether or not a professional surveyor should be used, and the answer to the FAQ may explain when, where, and why a professional surveyor should or should not be used. The FAQs could also be posed by and answered by a regional expert.

Warnings and checklists user interface element 30e may comprise information regarding areas in which contractors may cut corners and do a poor job; areas of common mistakes; areas where contractors may omit steps or materials; areas where special attention needs to be taken; regional problems and issues discussed by regional experts or the like; or combinations thereof. Checklists related to determinants of an acceptable level or performance for a predetermined stage may be provided, e.g. a list of recommended materials to use and relative costs, a list of the most frequent mistakes/problems encountered during construction, a list of common omissions, or the like, or a combination thereof.

“What's next” user interface element 30f may comprise a reminder about steps, e.g. comprising contractors and/or materials, which need to be scheduled for an upcoming stage or scheduled concurrently with a construction stage to keep the project on time.

Bid materials user interface element 30g may be used to provide a user with information related to materials suppliers in a predetermined stage as well as provide a standard bid request form for the details of a bid request. Additionally, bid materials user interface element 30g may provide a solicit bids function to allow solicitation from regional and/or national materials suppliers or manufacturers by either electronic mail, facsimile, toll free number, in person, or regular mail.

Bid services user interface element 30h may be used to provide a directory of service providers needed at a predetermined stage. The directory of providers of construction services is typically construction service context sensitive, e.g. it may change depending on the construction context currently selected, including filtering the directory based on a geographical location of the user and/or the construction project. The construction service context sensitive directory of providers of construction services may comprise a construction service context sensitive directory of providers of construction services, a construction service context sensitive directory of providers or manufacturers of construction materials, a construction service context sensitive bidding request form, or a construction service context sensitive bidding display, or the like, or a combination thereof.

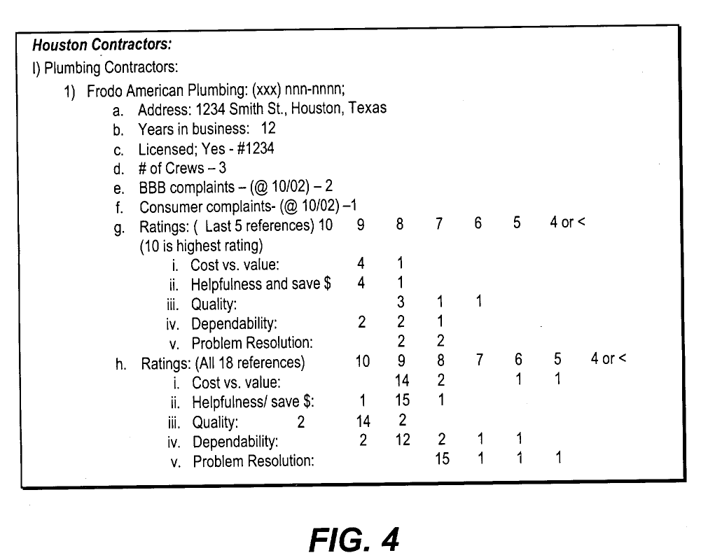

Additionally, the directory, i.e. of the providers of construction services and/or of construction materials, may further comprise information about and a customer rating for a predetermined set of the providers, such as a set of providers of construction services and/or construction material in a geographic region. Ratings may comprise indicia of cost versus value, quality of workmanship, responsiveness, dependability, clean up, problem solving or the like filled out by references or clients that have used the provider's services. The indicia may further be scaled such as on a 1 to 10 scale. For example, when a provider or contractor is initially admitted into the directory, the provider or contractor may be asked to provide one or more references. These references may be contacted and asked to rate the provider or contractor according to one or more predetermined indicia. These responses may be used to create an initial rating for that provider or contractor, an exemplar of which is shown in FIG. 4. As users of user interface 10 or system 1 (FIG. 1) employ these providers or contractors, ratings solicited from the users may be added to and incorporated in the provider or contractor indicia.

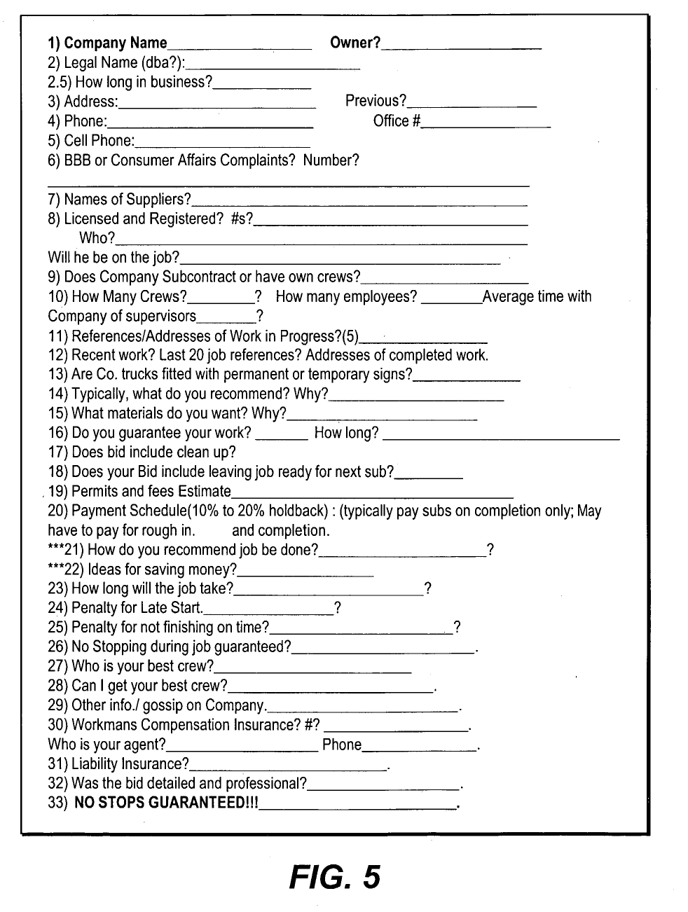

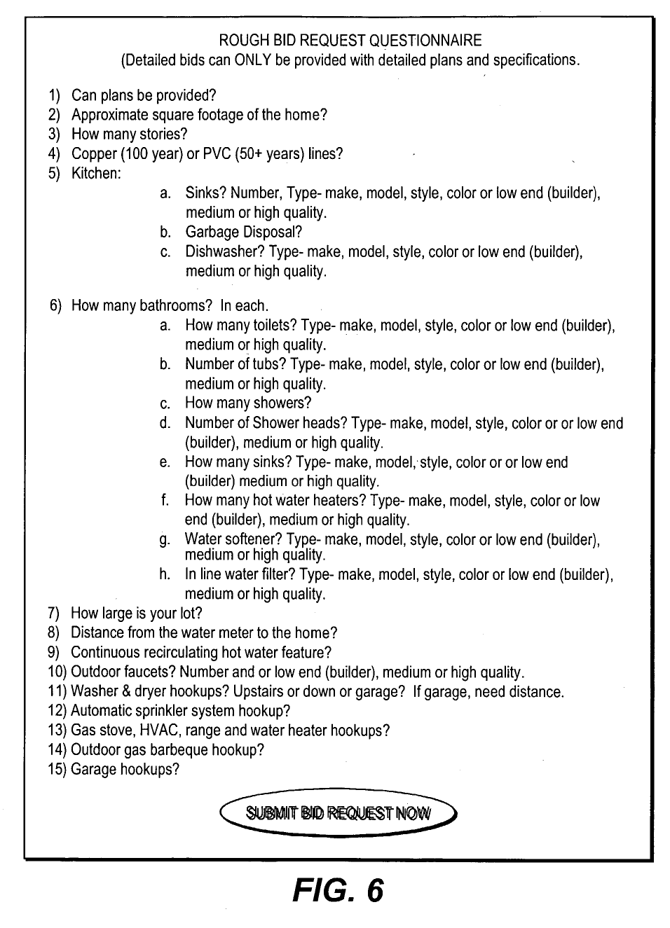

Access to one or more bidding services, such as via the directory, may allow the user, who may be a potential consumer of construction services, to provide one or more construction service providers with a request for a bid or additional information on a construction service related to the desired construction service context. Such construction service providers may be required, in order to participate in system 1 and be listed on the directory, to provide information, an exemplar of which is illustrated in FIG. 5. Additionally, a construction service provider who desires to bid on the requested services may, in turn, provide the consumer with a bid for such services. The bid may be provided by e-mail or stored, such as on persistent data store 55 (FIG. 1) accessible to server 50 (FIG. 1) for later retrieval and review by the user, such as using user interface 10 or via electronic mail, facsimile, regular mail, or dropped off in person. An exemplar of a bid request form is illustrated in FIG. 6.

Referring now to FIG. 7, a construction project plan timeline may be created using user interface 10 (FIG. 1). User interface 10 may be used to provide a potential consumer of construction services with access to resources required to accomplish the desired construction. User interface 10 may be available online such as through the Internet and the project plan created with user interface 10 may be tailored to a specific geographic region. In addition to providing information sufficient to create a project plan, system 1 (FIG. 1), using user interface 10, may further provide information on how to accomplish the project plan to initiate and complete the project as well as a directory of construction service providers and construction materials providers and a method to solicit bids or information from these providers, e.g. using user interface 10, electronic mail, facsimile, toll free number, or in person, or a combination thereof.

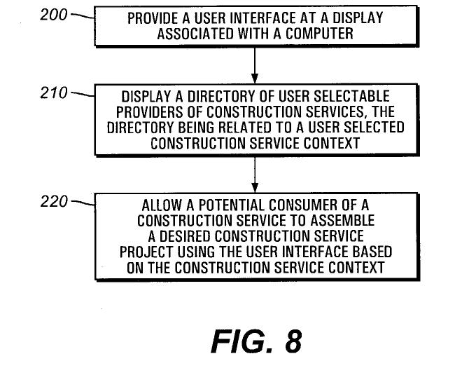

In the operation of an exemplary embodiment, referring now to FIG. 8, a user, who may be a potential consumer of construction service, is provided with user interface 10 (FIG. 1) at display 5 (FIG. 1) associated with computer 2 (FIG. 1), step 200. The user is allowed to assemble a desired construction service project, e.g. create a project plan (an exemplar of which is shown in FIG. 7) including a project timeline, using user interface 10 based on a construction service context selected by the user, or to estimate the cost of the project according to the project plan, or a combination thereof.

In an exemplary embodiment, a user who is a potential consumer of construction services may be allowed to access a project plan definition region of user interface 10 (FIG. 1) displayed at a computer 2 (FIG. 1), e.g. first region 12 (FIG. 1).

Using user interface 10 (FIG. 1), the potential consumer may define a project plan, which may further comprise a timeline, for a desired construction service where the project plan may be associated with a desired construction service context.

The user may be allowed to access a set of resources related to the project plan, e.g. financing, insurance, labor, material, and/or professional services. Additionally, resources may further comprise general and regional advice and information, services or products or the like, or combinations thereof,

Using a user selectable user interface element 20,30 (FIG. 1) on user interface 10 (FIG. 1), the potential consumer may further access one or more providers of one or more construction services, step 210. In a currently preferred embodiment, user interface 10 further provides a customer rating of the provider of the construction service, such as using a directory of such providers.

Additionally, the potential consumer may be allowed to provide one or more construction service providers with a request for a bid on services related to the desired construction service context, step 20. Construction service providers who desire to bid on the requested services may then provide the potential consumer with a bid such as by using electronic mail or an electronic reply accessible from user interface 10 (FIG. 1), facsimile, toll free number, in person, regular mail of construction plans or specifications, or combinations thereof.

In keeping with the description of exemplary embodiments described herein above, a project plan may be converted into an electronically manipulatable form of the desired construction service project, an electronic form of the desired construction service project viewable at a computer, a paper form of the desired construction service project, or the like, or a combination thereof.

When sufficient detail is present for the potential consumer's project plan, an estimate of the cost of the project plan may be generated such as by use of an estimating program geared to the region in which the construction will be located. This estimate may then be verified by bids submitted by the contractors and the materials providers in the region.

Thus, system 1 (FIG. 1), using user interface 10 (FIG. 1), may allow a potential consumer to define and obtain details from national or regional experts on not only what to do, but how to do what is needed, as well as access to the means to plan and execute their plan.

The user may access user interface 10 (FIG. 1) through computer 2 (FIG. 1) operatively in communication with data packet network 100 (FIG. 1) such as the Internet. Using user interface 10, the user may be provided with a project plan (FIG. 7) for construction service context desired by the user, e.g. a home construction or remodeling project. The project plan may comprise a chronologically arranged set of instructions, information, guidelines, materials, providers, and costs (e.g., estimated versus actual) useful to accomplish the desired construction service context. In a currently envisioned embodiment, access may be provided to the user interface for a fee, although access may be totally free or partially free. Providers and contractors may also pay a fee to be listed in a directory of providers and contractors.

By way of further example, a user may have selected a first user interface element 20 (FIG. 2) which sets the construction service context to an improvement to or remodeling of a residence, e.g. element 20c. The user may further desire to investigate finding financing. Accordingly, selectable user interface element 30d (FIG. 2), FAQ, may, when selected by the user, present the user with a predetermined set of frequently asked questions related to alternatives for financing and home improvement loans, home equity loans, and the like, or combinations thereof. For example, FAQ may include questions such as “Where do I get the down payment?,” “What do I do if I have bad credit?,” “What information do I have to give the mortgage company or bank?,” “If I have some money saved, should I spend it on the construction first and then go see the bank?,” “What is a ‘one time close’ mortgage loan?,” “How long should I take a mortgage out for: 15 years, 20 years, 30 years?,” along with answers to the FAQ.

Depending on the construction service context, advice from national or regional experts provided the user may comprise how to choose material for the desired construction service context; how to choose a contractor for the desired construction service context, the various construction options for each service context and what they cost relative to each other option, as well as advice about which construction options are recommended for each geographic region; general information related to the desired construction service context, warnings and checklists of desirable elements relevant to the desired construction service context, further steps in a timeline for a project related to the desired construction service context, or the like. Advice may further comprise display of a graphic on display 5 (FIG. 1) such as an illustration or a photographically derived demonstration such as a video demonstration or one or more photographic images, where the graphic is related to the desired construction service context, e.g. a representation of a step accomplished correctly and a representation of a step accomplished poorly.

As different geographical regions may have different building issues and/or differing requirements for dealing with building issues, advice may be augmented, developed, and/or presented to the user on a geographical basis, e.g. from an expert or other entity such as an inspector familiar with that geographic region. Accordingly, in an exemplary embodiment, advice additionally may be related to a specific geographic region, e.g. tailored or otherwise restricted to that specific geographic region. One or more “how to” user selectable interface elements 20,30 (FIG. 2) may reflect the geographic region for the desired construction context. In an alternative embodiment, a separate user selectable interface element 20,30 may be present to provide access to regional advice and/or regionally tailored warnings and checklist functionality.

In an exemplary embodiment, a project plan (FIG. 7) may comprise a chronologically sequenced set of information regarding the desired construction service project, i.e. stages. The set of information may further comprise step by step examples to be used such as for guidance in pursuing the construction plan, i.e. steps of each stage. In an exemplary embodiment, the step by step examples may further be segmented such as by stage of construction. For example, in a currently envisioned exemplary embodiment, segments may include a stage which occurs while planning to remodel or build, a pre-construction stage which occurs before the potential consumer engages in the construction services, a stage for foundation construction, a stage for structure construction, a stage for interior construction, a stage for exterior construction, a stage for a finishing construction, a stage for lot completion, and a stage for furnishing and/or upgrading the home.

Each stage may further set and/or further define a construction service context which is further detailed by the steps for that stage. For example, a stage for planning may include steps addressing mortgages, choosing and purchasing real estate, choosing a realtor, choosing an attorney, choosing an exterior facade, developing a construction plan, choosing an architect or designer, choosing upgrades for the project, estimating costs, choosing contractors, obtaining surveys and engineering drawings, obtaining additional information, and obtaining permits and approvals. These steps may occur before the potential consumer engages in the construction services and may set a construction context which further comprises information on alternatives, advice, guidelines, warnings, checklists, what steps to schedule either concurrently or next and/or frequently asked questions (FAQ) related to background information.

A pre-construction or structure construction stage may set a construction context which further comprises one or more steps to complete each stage. Each step may further comprise advice, both general and regional, or information, guidelines, warnings, checklists, “what's next,” FAQ, as well as a directory of contractors and materials available for bid related to each step of the stage. For example, a pre-construction stage may comprise steps including permits and approvals; elevation surveys; clearing the lot, e.g. of brush or other vegetation or other obstructions; obtaining temporary electricity, dumpster, and porta-potty services; site excavation and preparation; construction surveys; creation of foundation forms, drilling, and pouring footings or piers; sub-rough plumbing, sub-rough electrical and heating, and air conditioning services (HVAC); moisture barriers; termite spraying; foundation drainage, backfill, and rough grade; basement rough-in; and inspections.

A structure construction stage may set a construction context in which information, how to choose materials and/or service providers, advice, guidelines, checklists, warnings, FAQ or requests for additional information are related to each step of this stage, e.g. framing, sheathing and waterproofing such as housewrap, roofing and soffets, ridge vents, windows and exterior doors, rough plumbing, rough electrical, HVAC and gas lines, and inspections.

An interior construction stage may set a constriction context in which information, how to choose materials and/or service providers, advice, guidelines, checklists, warnings, FAQ, and/or requests for additional information are related to each step of this stage, e.g. wall insulation, drywall, finish carpentry, interior painting, floors, moldings, and inspections.

An exterior construction stage may set a constriction context in which information, how to choose materials and/or service providers, advice, guidelines, checklists, warnings, FAQ , and/or requests for additional information are related to each step of this stage, e.g. fascia work such as brick, siding, or stucco, completing porches, and inspections.

A lot completion stage may set a constriction context in which information, how to choose materials and/or service providers, advice, guidelines, checklists, warnings, FAQ, and/or requests for additional information are related to each step of this stage, e.g. final grading, sidewalks and driveway, electric and gas laterals tie ins, sodding, foundation plastering, and inspections.

A finish construction stage may set a constriction context in which information, how to choose materials and/or service providers, advice, guidelines, checklists, warnings, FAQ, and/or requests for additional information are related to each step of this stage, e.g. cabinets and counters, showers, tubs and tile, finish plumbing fixtures, finish electrical fixtures, finish HVAC, finish painting, and exterior painting, flooring, tiling and carpet, hardware, landscaping, final inspection, and miscellany such as punch lists and inspections.

With each stage, certain definitions used in the construction context may be eliminated or expanded, such as depending on geographic or other factors. For example, basements are relatively unknown and unused in certain portions of the United States and may be excluded if the user or project is located in such a portion of the United States. Further, as each construction context is set, user selectable elements 20,30 (FIG. 2) may further comprise user selectable video or other graphic presentations which are related to the construction context and which provide additional information such as a “how to” tutorial for an item relevant to the construction context.

Once assembled, the construction service project may be converted into an electronically manipulatable form of the desired construction service project, an electronic form of the desired construction service project viewable at a computer, a paper form of the desired construction service project, or the like, or a combination thereof. For example, a project plan (FIG. 7) may be created and sent via electronic means to the user such as with e-mail or printed such as on printer 6 (FIG. 1).

In an exemplary embodiment, the user may further be provided with a user selectable directory of construction service providers at any point during use of user interface 10. The user selectable directory may comprise a user selectable user interface element 20,30 (FIG. 2) which, when selected, provides access to a desired construction service provider in a particular geographic region available from the directory, information and customer ratings for a predetermined set of construction service providers in a currently displayed directory of construction service providers, information and consumer ratings for materials associated with a predetermined set of construction service providers in the currently displayed directory of construction service providers, or the like, or a combination thereof.

Content of the user selectable directory may be limited to a geographic area such as may specified by a geographic limit option, e.g. by use of a user login. Additionally, content of the user selectable directory may be limited to construction service providers associated with the desired construction service context, limited to construction service providers associated with a currently selected user interface element, or the like. For example, a user login associated with a user located in Houston, Tex. may restrict user access to content of the user selectable directory limited to a predetermined geographic area around Houston, Tex.

The user may wish further information regarding building material available from one or more construction service providers or may wish to solicit one or more bids for one or more construction services, e.g. labor. If a user so desires, the user may further access information or other features of the construction service provider such as by online access to additional information about the desired construction service provider or online access to bid solicitor for the desired construction service provider. The additional information may comprise a name, an address, contact information, and the like and may be obtained using user interface 10, electronic mail, facsimile, toll free number, in person or a combination thereof.

In an embodiment, users may be provided with access to a bulk provider or a manufacturer of material related to the desired construction service context. In such an embodiment, users may further be provided with shipment of material from the bulk provider of materials such as by using a break bulk distributor. In this manner, cost of the material may be lessened for the user.

It will be understood that various changes in the details, materials, and arrangements of the parts which have been described and illustrated above in order to explain the nature of this invention may be made by those skilled in the art without departing from the principle and scope of the invention as recited in the appended claims.

We claim:

1) A user interface, comprising:
a. a first region, displayable on a display associated with a computer, the first region comprising a first user interface element useful for setting a construction service context;
b. a second region, displayable on the display associated with the computer, the second region comprising a second user selectable user interface element useful for providing additional information in a construction service context defined by a selection of a user interface element in the first region; and
c. a construction service context sensitive directory of providers of construction services, the construction service context sensitive directory operable to be invoked by at least one of (i) the first user interface element or (ii) the second user interface element.

2) A user interface according to claim 1, wherein:
a. the construction service context sensitive directory of providers of construction services comprises at least one of (i) a construction service context sensitive directory of providers of construction services, the construction service context sensitive directory of providers of construction services further comprising information and a customer rating for a predetermined set of the providers of construction services in a geographic region, (ii) a construction service context sensitive directory of providers of construction materials, the construction service context sensitive directory of providers of construction materials further comprising information and a customer rating for a predetermined set of the providers in a geographic region, (iii) a construction service context sensitive bidding display; (iv) a construction service context sensitive warning listing; (v) a construction service context sensitive checklist, or (vi) information relevant to a construction service context sensitive building alternative.

3) A user interface according to claim 1, wherein:
a. the first user interface element comprises a graphical component, the graphical component being visually related to the construction service context.

4) A user interface according to claim 3, wherein:
a. the first user interface element comprises a plurality of graphical components, the graphical components arranged in an outline format where at least one first user interface element exists for each of a predetermined set of stages of construction.

5) A user interface according to claim 3, wherein:
a. a graphical component further comprises at least one of (i) a photographic image, (ii) a graphic, or (iii) text.

6) A user interface according to claim 1, wherein:
a. the construction service context comprises at least one of (i) a new residential construction project, (ii) an existing residential construction project, (iii) an existing residential maintenance project, (iv) a new non-residential construction project, (v) an existing non-residential construction project, or (vi) an existing non-residential maintenance project.

7) A user interface according to claim 1, wherein:
a. the second user selectable user interface element further comprises a plurality of user selectable user interface elements, each user selectable user interface element of the plurality of user selectable user interface elements being useful to provide a predetermined response related to the construction service context upon selection of that user selectable user interface element.

8) A user interface according to claim 7, wherein:
a. the predetermined response comprises at least one of (i) access to a project plan definition tool, (ii) display of an explanation of an element of the construction service context, (iii) display of advice related to a characteristic of and element of the construction service context, (iv) display of advice related to a characteristic of and element of the construction service context step, or (v) access to one or more bidding services.

9) A user interface according to claim 8, wherein:
a. the advice comprises at least one of (i) how to choose material for the desired construction service context, (ii) how to choose a contractor for the desired construction service context, (iii) general information related to the desired construction service context, (iv) advice from experts local to a predetermined geographic region, (v) warnings and checklists relevant to the desired construction service context, (vi) further steps in a timeline for a project related to the desired construction service context, (vii) how to choose material for the desired construction service context step, (viii) how to choose a contractor for the desired construction service context step, (ix) general information related to the desired construction service context step, (x) warnings and checklists relevant to the desired construction service context step, and (xi) a further construction service context step in a timeline for a project related to the desired construction service context step.

10) A user interface according to claim 8, wherein:
a. the advice further comprises display of a photographically derived demonstration on the display, the photographically derived demonstration being related to the desired construction service context.

11) A user interface according to claim 8, wherein:
a. the displayed advice is related to geographical region.

12) A user interface according to claim 8, wherein:
a. access to one or more bidding services further comprises:
i. a user interface element useful to allow the consumer to provide a construction service provider with a request for a construction service related to the desired construction service context; and
ii. a user interface element useful to provide the consumer with a bid from the construction service provider if the construction service provider desires to bid on the requested services.

13) A user interface according to claim 12, wherein:
a. the construction service provider comprises at least one of (i) a financial service provider, (ii) an insurance service provider, (iii) a construction materials provider, (iv) a construction labor provider, (v) an architect, home designer or engineering service provider, (vi) a surveying services provider, (vii) an inspection services provider, (vii) a real estate brokerage services provider, (ix) an interior designer, (x) an exterior designer, (xi) a landscape designer (xii) a lighting designer, (xiii) a pool designer, or (xiv) a construction legal services provider.

14) A method of providing access to a construction service, comprising:
a. providing a user interface at a display associated with a computer, the user interface comprising:
i. a first display region comprising a first selectable user interface element useful for setting a construction service context; and
ii. a second display region, further comprising a second selectable user interface element useful for providing a predefined response to a selection of the second user interface element;
b. displaying a directory of user selectable providers of construction services, the directory being related to the construction service context; and
c. allowing a potential consumer of a construction service to assemble a desired construction service project using the user interface based on the construction service context.

15) A method according to claim 14, further comprising:
a. accessing the user interface by the potential consumer through a computer operatively in communication with a data packet network.

16) A method of claim 14, further comprising:
a. creating a project plan for the assembled desired construction service project, the project plan comprising a chronologically arranged set of instructions useful to accomplish the desired construction service context.

17) A method of claim 16, wherein:
a. the project plan further comprises an estimated costs for a predetermined subset of the set of instructions.

18) A method of claim 15, further comprising:
a. providing access to the user interface for at least one of (i) a fee charged to the user or (ii) a fee charged to a provider, supplier, distributor, professional, or manufacturer who obtains a sale through a user's use of the user interface.

19) A method of claim 14, further comprising:
a. limiting contents of the directory to at least one of (i) construction service providers in a geographic area specified by a geographic limit option, (ii) construction service providers associated with the desired construction service context, or (iii) construction service providers associated with a currently selected user interface element.

20) A method of claim 14, wherein:
a. the directory further comprises at least one of (i) a user selectable user interface element to access a desired construction service provider from the directory, (ii) a rating for a predetermined set of construction service providers in the currently displayed directory of construction service providers or (iii) a rating for material associated with a predetermined set of construction service providers in the currently displayed directory of construction service providers.

21) A method of claim 14, wherein:
a. access comprises at least one of (i) online access to additional information about the desired construction service provider or (ii) online access to a bid solicitor for the desired construction service provider.

22) A method of claim 14, further comprising:
a. providing direct access to a manufacturer of material directly or through a bulk provider of material related to the desired construction service context; and
b. providing shipment of material from a bulk provider of material using a break bulk distributor.

23) A method of claim 14, further comprising:
a. converting an assembled desired construction service project into at least one of (i) an electronically manipulatable form of the desired construction service project, (ii) an electronic form of the desired construction service project viewable at a computer, or (iii) a paper form of the desired construction service project.

24) A method of creating a construction project plan for a desired construction service, the method comprising:
a. allowing a potential consumer of a construction service to access a first region of a user interface displayed on a computer display, the first region defining a project plan definition region of the user interface;
b. using the user interface by the potential consumer to set a desired construction service context;
c. using the user interface by the potential consumer to define a timeline for a project, the project comprising a desired construction service, the project associatable with the desired construction service context;
d. allowing the potential consumer of construction services to access a set of construction service providers related to the project for a predefined geographic area;
e. providing a user selectable user interface element on the user interface for the potential consumer to access a provider of a construction service, the user interface further providing a rating of the provider of the construction service; and
f. creating a project plan using the construction service context.

25) A method according to claim 24, further comprising:
a. allowing the potential consumer to provide a construction service provider with a request for a bid on services related to the desired construction service context; and
b. providing the consumer with a bid from the construction service provider if the construction service provider desires to bid on the requested service.

26) A method according to claim 25, wherein:
a. the consumer is provided with the bid electronically using at least one of (i) the user interface, (ii) electronically, or (iii) through a paper copy.

27) A method according to claim 24, further comprising:
a. generating an estimate of the cost of the project plan.

28) A method of claim 24, further comprising:
a. converting a created a timeline into at least one of (i) an electronically manipulatable form of the created timeline, (ii) an electronic form of the created timeline viewable at a computer, or (iii) a paper form of the created timeline.

29) A method of claim 24, wherein:
a. the project plan further comprises a plurality of stages, the stages comprising at least one of (i) a planning stage; (ii) a pre-construction stage, (iii) a foundation stage, (iv) a structure construction stage, (v) an interior construction stage, (vi) an exterior construction stage, (vii) a finish construction stage, (viii) a lot completion stage, or (ix) a home furnishing stage.

30) A system for providing access to a construction planning services, comprising:
a. a server, further comprising a persistent data store;
b. a user computer, further comprising a display;
c. a data network, operable to operatively connect the server and the user computer; and
d. a user interface displayable on the display and operable to provide access to a predetermined set of functions through use of one or more selectable user interface elements, at least one selectable user interface element being useful to set a construction service context, at least one selectable user interface element being useful to provide access to a construction service context sensitive directory of providers of construction services.
